(19) United States
(12) Patent Application Publication
(10) Pub. No.: US 2018/0255358 A1
(43) Pub. Date: Sep. 6, 2018

(54) METHOD, SYSTEM AND DEVICE FOR INTERACTION DURING VIDEO PLAYBACK

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Jianwei GUO, BEIJING (CN)

(21) Appl. No.: 15/120,363

(22) PCT Filed: May 27, 2016
(86) PCT No.: PCT/CN2016/083722

§ 371 Date: Aug. 19, 2016

(30) Foreign Application Priority Data
Nov. 26, 2015 (CN) 201510836982.2

(51) Int. Cl. H04N 21/4788; H04N 21/258; G06Q 50/00

(52) U.S. Cl. CPC H04N 21/4788; G06Q 50/01; H04N 21/25891

(57) ABSTRACT

The invention is a method, system and device for interaction during video playback, while playing the video file, the user acquires a preset user list of the video file, wherein the preset user list stores the other users' information who are playing the video file; and stores these users related information into the page of the video file being played. Through the invention a user can access the user information of other user who is watching the video, and the video user can select and interact with the other user who may have the similar interest and preference; and further the invention can provide the solutions such as establishing one to one chat channel or multi-user discussion group for the users who are watching the video together, so that the users can perform various interactions while watching the video to enhance the interactive function of the video sites and applications.

### CROSS-REFERENCE TO RELATED APPLICATIONS

This application is a continuation application of International Application No. PCT/CN2016/083722, filed May 27, 2016, which is based upon and claims priority to Chinese Patent Application No. 201510836982.2, filed on Nov. 26, 2015, the entire contents of which are incorporated herein by reference.

### TECHNICAL FIELD

The present application relates to a field of multimedia control technology, and more particular to a method, system and device for interaction during video playback.

### BACKGROUND

With the rapid development of network technology, the demand for network is reflected in every corner of peoples' lives: various shopping websites make the e-commerce industry into a golden age, various search engines facilitate the daily life of people, and a variety of social applications and websites do not only stimulate people's desire for social, but also narrow the distance between people. The total number of users of the world's largest social networking platform “Facebook” has exceeded 2 billion, and other types of social platforms are also in rapid development. That is, the social network has been integrated into every corner of peoples' lives and began to cause a profound impact on the society.

In addition to specifically providing sites or applications of social services, other network service suppliers are also trying to incorporate the social features into themselves to provide more comprehensive services. In the online video industry, most of the video service suppliers provide many functions such as message in the station, recommending channel, comments to share, bullet curtain which is increasingly popular in recent years and other functions, to facilitate the communication between users.

In the course of implementing the present application, the inventors have found that in the prior art there are at least the problems that: the social functions still have a time delay for the network video services and it is difficult to reflect the real-time communication. Therefore, the current video applications are still only provide the function of video playback in general and cannot achieve a real-time communication of social network.

### SUMMARY

In view of this, an object of an embodiment of the present application is to provide a method, system and device for interaction during video playback, for satisfying the demands of real-time communication of users when using a video application.

Based on the above-described object of the embodiment of the present application, there is provided a method for interaction during video playback, which is applied in a server, comprising:
when a user starting to play a video file, establishing an association of user information of a user with the video file in a preset user list, wherein the user list is used for multi-users access;
during the video file being played by the user, acquiring user information of other users who are playing the video file from the user list, and pushing the user information of the other users to a display page of the played video file; and
when ending the playing of the video file, removing the association of the user information of the user with the video file from the user list.

In some alternative embodiments, wherein the pushing the user information of the other users to the display page of the video file comprises:
acquiring playback preferences of the other users, wherein the playback preference is a ratio of the number of each type of video files played by any user to the number of all video files played by the same user;
comparing the playback preference of the user with the playback preferences of the other users to obtain a preference similarity; and
when pushing the user information, preferably pushing the user information of those of the other users who have a high preference similarity to the user.

In some alternative embodiments, wherein after pushing the user information of the other users to the display page of the video file, the method further comprises a step of adding the other users as the user's friends, which comprises:
according to the pushed user information of the other users, selecting at least one of the other users to send a friend request, wherein the friend request includes the user information of the user and the playback preference of the user;
popping up a tab including the user information and the playback preference of the user in the page of the video file being played by the selected user; and
if receiving a confirmation of the friend request from the selected other user, adding the selected other user into a friend list of the user.

In some alternative embodiments, wherein after pushing the user information of the other users to the display page of the playing video file, the method further comprises:
acquiring a friend list of the user which comprises the user information of a friend of the user;
searching the user information of the friend in the user information of the other users; and
highlighting the user information of the friend.

In some alternative embodiments, wherein after the step of pushing the user information of the other users to the display page of the video file, the method further comprises the steps of:
acquiring an interaction request of the user sent to the other user, wherein the interaction request comprises a type of interactive application;
when receiving a confirmation of the interaction request returned from the other user, sending a resource request to the server, wherein the resource request includes a storage space size and a network bandwidth; and
when receiving a confirmation of the resource request from the server, adding the user into the interactive application designated by the interaction request.

In some alternative embodiments, wherein the type of interactive application comprises chat channel, discussion group, online screening room; wherein the chat channel comprises a network link between two users and interactive windows respectively arranged in the video playback pages of respective users;

the discussion group comprises a network link between two or more users and interactive windows respectively arranged in the video playback pages of respective users; and the online screening room comprises a network link between two or more users, a video transmission link between multiple users and the server, and interactive windows which are independent of the video playback pages of respective users respectively and have a function of playing a video.

Another aspect of an embodiment of the present application provides a system for interaction during video playback, including:
a display unit, configured to display a video playback page;
a service unit, configured to store a user list and video files and further configured to provide other service supports, wherein the user list is used for multi-user access;
an associating unit, configured to establish an association of user information of the user with the video file in a preset user list when a user starting to play a video file, and remove the association of the user information of the user with the video file from the user list when ending the playing of the video file; and
a pushing unit, configured to acquire user information of other users who are playing the video file from the user list during the video file being played by the user, and push the user information of the other users to a display page of the played video file.

In some alternative embodiments, the pushing unit includes a playback preference comparing module, configured to acquire playback preferences of the other users, wherein the playback preference is a ratio of the number of each type of video files played by any user to the number of all video files played by the same user; comparing the playback preference of the user with the playback preferences of the other users to obtain a preference similarity; and when pushing the user information, preferably pushing the user information of those of the other users who have a high preference similarity to the user.

In some alternative embodiments, the system further includes:
a friend adding unit, configured to select at least one of the other users to send a friend request according to the pushed user information of the other users, wherein the friend request includes the user information of the user and playback preference of the user; popping up a tab including the user information and the playback preference of the user in the page of the video file being played by the selected user; and if receiving a confirmation of the friend request from the selected other user, adding the selected other user into a friend list of the user.

In some alternative embodiments, the pushing unit is configured to acquire a friend list of the user which includes the user information of a friend of the user; search the user information of the friend in the user information of the other users; and highlight the user information of the friend.

In some alternative embodiments, the system further includes:
an interaction processing unit, configured to acquire an interaction request of the user sent to the other user, wherein the interaction request includes a type of interactive application; when receiving a confirmation of the interaction request returned from the other user, the interaction processing unit is configured to send a resource request to the server, wherein the resource request includes storage space size and network bandwidth; and when receiving a confirmation of the resource request from the server, adding the user into the interactive application designated by the interaction request.

In some alternative embodiments, the interaction processing unit includes:
a chat channel module, configured to control a chat channel, wherein the chat channel includes a network link between two users and interactive windows respectively arranged in the video playback pages of respective users;
a discussion group module, configured to control a discussion group, wherein the discussion group includes a network link between two or more users and interactive windows respectively arranged in the video playback pages of respective users; and
an online screening room module, configured to control an online screening room, wherein the online screening room includes a network link between two or more users, a video transmission link between multi-users and the server, and interactive windows which is independent of the video playback pages of respective users respectively and have a function of playing a video.

Yet another aspect of an embodiment of the present application further provides adevice, including:
one or more processor(s); and
a memory for storing an operating instruction; wherein the one or more processor(s)is/are configured to acquire the operation instruction from the memory to execute:
when starting to play a video file, establishing an association of user information of a user with the video file in a preset user list, wherein the user list is used for multi-user access;
during the video file being played by the user, acquiring the user information of other users who are playing the video file from the user list, and pushing the user information of the other users to a display page of the video file; and
when ending the playing of the video file, removing the association of the user information of the user with the video file from the user list.

In some alternative embodiments, the processor is further configured to execute:
acquiring playback preferences of the other users, wherein the playback preference is a ratio of the number of each type of video files played by a user to the number of all video files played by the same user;
comparing the playback preference of the user with the playback preferences of the other users to obtain a preference similarity; and
when pushing the user information, preferably pushing the user information of those of the other users who have a high preference similarity to the user.

In some alternative embodiments, the processor is further configured to execute:
according to the pushed user information of the other users, selecting at least one of the other users to send a friend request, wherein the friend request includes the user information and playback preference of the user;
popping up a tab including the user information and the playback preference of the user in the page of the video file being played by the selected user; and
if receiving a confirmation of the friend request from the selected user, adding the selected other user into a friend list of the user.

In some alternative embodiments, the processor is further configured to execute:
acquiring a friend list of the user which comprises the user information of a friend of the user;
searching the user information of the friend in the user information of the other users; and
highlighting the user information of the friend.

In some alternative embodiments, the processor is further configured to execute:
acquiring an interaction request of the user sending to the other user, wherein the interaction request includes comprises a type of interactive application;
when receiving a confirmation of the interaction request returned from the other user, sending a resource request to the server, wherein the resource request include storage space size and network bandwidth; and
when receiving a confirmation of the resource request from the server, adding the user into the interactive application designated by the interaction request.

In some alternative embodiments, the types of interactive application include chat channel, discussion group, online screening room; wherein
the chat channel includes a network link between two users and interactive windows respectively arranged in the video playback pages of respective users;
the discussion group includes a network link between two or more users and interactive windows respectively arranged in the video playback pages of respective users; and
the online screening room includes a network link between two or more users, a video transmission link between multi-users and the server, and interactive windows which is independent of the video playback pages of respective users respectively and have a function of playing a video .

As can be seen from the above, the method, system and device for interaction during video playback provided by the embodiments of the present application can provide the user information of other user who is watching the video for the video user and select the other user who has the similar interest and preference with the user as an interactive target of the user; and further can provide the solutions such as establishing one to one chat channel or multi-user discussion group for the users who are watching the video together, so that the users can perform various interactions while watching the video to enhance the interactive function of the video sites and applications.

### BRIEF DESCRIPTION OF THE DRAWING(S)

FIG. 1 is a schematic flowchart of a method for interaction during video playback according to an embodiment of the present application;

FIG. 2 is a schematic flowchart of a method for interaction during video playback according to another embodiment of the present application;

FIG. 3 is a timing diagram of a method for interaction during video playback according to yet another embodiment of the present application; and

FIG. 4 is a schematic view of a system for interaction during video playback according to an embodiment of the present application.

### DETAILED DESCRIPTION

The present application is described more fully hereinafter with reference to the accompanying drawings so that the objects, technical solutions and advantages of the present application will become more apparent.

The existing video playback technology usually provides a commenting function. In recent years, it is occurred a scroll subtitles called as “bullet curtain”, which can send the comments into the video window in accordance with the time points so as to improve the interaction between video users to a certain extent. However, all such functions lack of an effective communication method, even if the user can share the feeling with other co-viewers by the manners such as the bullet curtain, but since the bullet curtain or comments has a time delay, so that it is unable to perform a real-time communication between the users and unable to further search other users with a common preference with himself, which resulting in that the current video website is just a supplier of video sources and cannot become the center of the social network.

In order to improve the real-time interactive function of the video website and provide a new interactive platform for users, the embodiments of the application provide a method and system for interaction during video playback.

Now a method for interaction during video playback according to an embodiment of the present application is described.

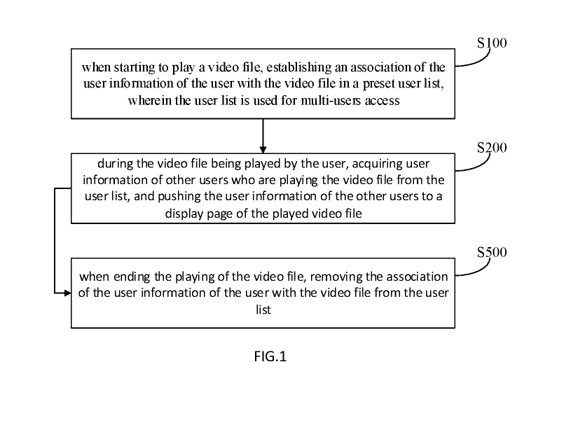

FIG. 1 is a schematic flow diagram of a method for interaction during video playback according to an embodiment of the present application. As shown, the method includes the step of:
S100:when starting to play a video file, establishing an association of user information of a user with the video file in a preset user list, wherein the user list is established in a web server.

Specifically, the step of S100 includes the steps of:
S101: starting to play a video file;
S102: sending the user information of the user to the web server at the user; and
S103: establishing an association of the user information of the user with the video file in the user list at the network server.

Specifically, the user list is not restricted as a “table”, but is a collection including user information of the user. Further, the user information includes a name, a video preference, a personal interest of the user and so on, and the user can set a default value for the items whether discloses the user information or not or for information which items are disclosed.

When the user starts to play a video file, only if a specific action such as “open a video file”, “click on a playback link” or “start to download a video file” executed by the user is detected, then it can be determined the user starts to play the video file. At the same time, an association of the user information of the user with the video file is established in the user list to update the user list. When a subsequent user plays the video file, the user information of the user can be found via the association to obtain the push of the user information of the user.

The user list can be provided with all user information of user in advance, and the “establishing an association of the user information of the user with the video file” at this time can includes the steps of acquiring a marker of the video file (for example, the name of the video file in the server or the playback link of the video file, etc.); associating the marker with the user information. The user list also can be provided with all video files in advance, and the “establishing an association of the user information of the user with the video file” at this time can includes the steps of acquiring a marker of the user (for example, the username or ID of the user, etc.); associating the marker with the video file.

Furthermore, before executing the step of S100, the method can also include the steps of inquiring whether the user agrees to login the user's own information, or directly putting the user information of the user into public, not to public or into partially public based on the user's default privacy option.

The method further includes the step of:
S200: during the video file being played by the user, acquiring the user information of other users who are playing the video file from the user list, and pushing the user information of the other users toa display page of the video file.

There are many alternatives for the step of pushing the user information of the other users to a display page of the playing video file. For example, when the user clicks on a button, a window is ejected and the other users' user information is displayed in the window; or during the playback of the video file, an specific additional display window is provided at the bottom, a side or other positions of the video playback window and the other users' user information is displayed in the additional display window; or the other users' user information is scroll displayed in a window.

The object of pushing the other users' user information is to let the user know the information of the other users who are playing the same video file as the user, since it may be a large probability event that those users have a similar playback preference with the user, those users can be a primary group of the user's new friends.

The method further includes the step of:
S500: when stopping to play the video file, removing the association of the user information of the user with the video file from the user list.

Specifically, the step of S500 includes the steps of:
S501: the user stopping to play the video file;
S502: the user send an end-playing video file message to the web server; and
S503: when the network server receiving the end-playing video file message, removing the association of the user information of the user with the video file.

Thus, the automatic updating of the user list can be achieved by executing the steps of S100 and S500 to ensure that the users in the user list are always the users who are playing the video file.

In some alternative embodiments, the step of S200 for pushing the user information of the other users to a display page of the video file can further include the steps of:
S210: acquiring playback preferences of the other users, wherein the playback preference is a ratio of the number of each type of video files played by any user to the number of all video files played by the same user.

The playback preference of the embodiment is simply set as a ratio of the number of each type of video files played by a user to the number of all video files played by the same user, which is consistent with the setting manner of the most video supplier. Indeed, a time determining condition can be further added, that is, the video watched by the user recently can increase the weighting of video type thereof and the video watched by the user before long time can decrease the weighting of the video type thereof. For example, when calculating the amount of video type of the recent playing video, each video may be multiplied by a factor more than 1; and in the same way, when calculating the amount of video type of the long time before playing video, each video may be multiplied by a factor less than 1. As a result, the user's recent preferable video type can be more evident, while the other users expecting to make a friend with the user can learn the user's recent playback preference, so as to more accurately determine whether there is a common topic with the user.
S220, comparing the playback preference of the user with the playback preferences of the other users to obtain a preference similarity.
S230: when pushing the user information, preferably pushing the user information of those of the other users who have a high preference similarity to the user.

There are many alternatives for the step of preferable pushing. For example, the other users having a high similarity can be arranged in front of the list to push, or be highlighted, or be listed separately by a frame to highlight. It is an object to cause the user's attention and make the user can easily acquire the user information of this part of users.

Further, in another embodiment, as an optional implementation of comparing the playback preference of the user with the playback preferences of the other users to obtain a preference similarity, the step of S220 includes the sub-steps of:
S2201, acquiring the ratio of various video types in the watching history of the user and the other users.
S2202, comparing the ratio of one video type of the user with the ratio of the same video type of another user in the other users and remaining the smaller ratio as a common ratio of the video type.
S2203, obtaining the sum of all the common ratios to obtain the similarity of watching history of the user with another user.
S2204, repeating the above steps until all the users in the current user list are accessed.

As an example of the above steps S2201-S2204, there are user A and user B, wherein the ratio of the amount of watched videos of the video type i of user A to the amount of all watched videos of user A is ad, and the ratio of the amount of watched videos of the video type i of user B to the amount of all watched videos of user B is bᵢ, and the range of i is (1, n), in which n is the total number of video types. Provided that sᵢ is a common ratio of the watched videos of the video type i of both users, then:

$${s}_{i} = \{ \begin{matrix}{a}_{i} , {a}_{i} \leq {b}_{i} \\ {b}_{i} , {b}_{i} < {a}_{i}\end{matrix} \qquad ( 1 )$$

If SAB shows the similarity of the watching history of user A and user B,

$${S}_{AB} = {\sum }_{i = 1}^{n} {s}_{i} \qquad ( 2 )$$

so the similarity of the watching history of user A and user B is obtained.

As a further specific example, if the number of video types is 3, the ratios of user A watching the 3 video types are a₁=0.2, a₂=0.3, a₃=0.5, and the ratios of user A watching the 3 video types are b₁=0.5, b₂=0.3, b₃=0.2, then the similarity of the watching history of user A and user B is S_{AB}=0.2+0.3+0.2=0.7.

Taking into account some special situations, for example, if the number of video types is 5; user A only watched three types of video and the ratios respectively area₁=0.6, a₂=0.2, a₃=0.2; user B only watched three types of video and the ratios respectively are b₁=0.6, b₄=0.2, b₅=0.2; then the similarity of the watching history of user A and user B is S_{AB}=0.6+0+0+0+0=0.6. Compared with the previous example, as for the similarity value, the similarity of both users in the previous examples is higher than that in the latter example, but 60% of the video types is completely the same when the both users are watching video in the latter example, which proves that they have a well-established common preference, so that the above method in determining these special users will be some deviation.

Thus, there is provided an alternative embodiment including when the common ratio of the video having the video type i watched by both users is higher than a certain value (e.g., higher than 0.5), it is multiplied by a factor greater than 1 in order to increase the importance of this type videos in calculating the similarity. This factor may be a staged value, e.g., the factor can be 1.1 at the common ratio of 0.5-0.6, 1.2 at the common ratio of 0.6-0.7, 1.3 at the common ration of 0.7-0.8 and so on. Of course, the actual values need to go through the user community sampling surveys to obtain more accurate values. In this way, the user community with a special preference for a specific type of videos can be filtered and recommended.

In addition to the calculation method of the embodiment, the other methods of similarity statistics by using the existing mathematical concept can also be applied into the present embodiment. In actual implementation, the more accurate and time-saving calculation method can be selected to improve the user experience.

In some preferred embodiments, the step of S200 may further include the steps of:
S240: finding the user's friends in the user list.
S241, when pushing the user information, preferably pushing the friends in the user list. the steps of S240 and S241 can allow the user to be visually informed of who are the user's own friends in all users watching the video together with the user, so as to be able to select friends to chat.

Further, alternatively, the step of S200 further includes the steps of:
S250: searching the user information of the friend from the user information of the other users and highlighting the user information of the friend.

Specifically, the step of S250 includes the sub-steps of:
S251:the user providing the user information of the friend to the network server;
S252:the network server searching the user information of the friend in the user list, and if finding the user information of the friend then executing the step of S253; otherwise, returning a message of not found;
S253: the network server sending a message of finding the user information of the friend to the user; and
S254, when receiving the message of finding the user information of the friend, highlighting the user information of the friend.

This embodiment allows the user to more clearly know who are playing the video file in his friends and the friends invited by the user to watch the video file can be highlighted to convenient for the user selection.

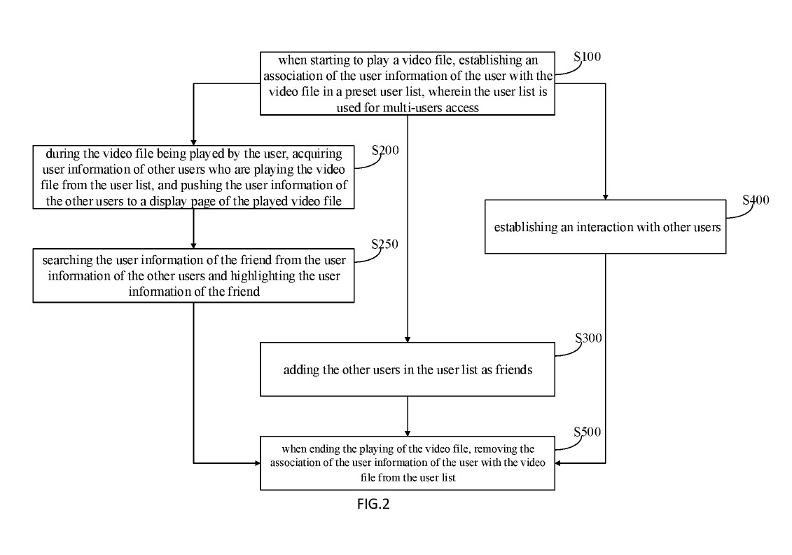

FIG. 2 is a schematic flow diagram of a method for interaction during video playback according to another embodiment of the present application. As shown, after the step of S200 for pushing the user information of the other users to a display page of the video file, the method further includes the step of S300 for adding the other users in the user list as friends, including the steps of:
S310: according to the pushed user information of the other users, selecting at least one of the other users to send a friend request, wherein the friend request includes the user information of the user and the playback preference of the user;
S320: popping up a tab including the user information of the user and playback preference in the pages playing the video file by the other users, wherein the tab further includes a accept button and a reject button, and if the other users click on the accept button then a friend request confirmation will be sent to the user, and if the other users click the reject button, then no message will be sent or a reject message will be sent to the user;
S330: if receiving a confirmation of the friend request from the selected other user, adding the selected other user into a friend list of the user.

The above-described steps achieve that when a user plays a video file, if the user found another user of interest in the user list, then the user can send a friend request directly to him, and if the friend request is rejected or accepted by him then returning a corresponding confirmation message. This function allows that the video-viewing is no longer only a simple push of media resources, but also become an interactive dating means.

In a preferred embodiment, referring to FIG. 2 again, in addition to the step of S200 for pushing the user information of the other users to a display page of the playing video file, the method further includes the step of S400 for establishing an interaction, including the steps of:
S410:acquiring an interaction request of the user send to the other user, wherein the interaction request comprises a type of interactive application; specifically, the step of S410 further including a step of S411: when the interaction request being received by the other user, sending an interaction request confirmation message to the user;
S420: when receiving a confirmation of the interaction request returned from the other user, sending a resource request to the server, wherein the resource request includes a storage space size and a network bandwidth; specifically, the step of S420 further including a step of S421:after the requested resource being prepared by the server, sending a resource request confirmation to the user, and at the same time, sending a resource request confirmation to the object of the interaction request;
S430: when receiving a confirmation of the resource request from the server, adding the user into the interactive application designated by the interaction request and also adding the object of the interaction request into the interactive application designated by the interaction request.

When receiving the pushed user information of the other users, the user can select a user of interest to send him an interaction request to establish a communication, and if they both have a common language then they can be developed as friends to improve the user's interactive network. In addition, the object of interaction can also be a user's friend.

Specifically, the types of interactive application include, but not limited to, chat channel, discussion group, online screening room; wherein
the chat channel includes a network link between two users and the interactive windows respectively arranged in the video playback pages of respective users, and the interactive content of the chat channel includes text chat and voice chat;
the discussion group includes a network link between two or more users and the interactive windows respectively arranged in the video playback pages of respective users, and the interactive content of the discussion group also includes text chat and voice chat; and
the online screening room, as a special type of interactive application provided by the embodiment for the precondition of video playback, includes a network link between two or more users, a video transmission link between multi-users and the server, and the interactive windows respectively arranged in the video playback pages of respective users. The interactive window does not only include a text input window or a voice input button, but also include a video playback area. The administrator of the screening room can decide to play which videos and the users in the screening room can be interactive. This is an interactive application similar with the real cinema in which the users can be interactive. The administrator can organize some activities by using the video playback function to improve the interactivity between the users.

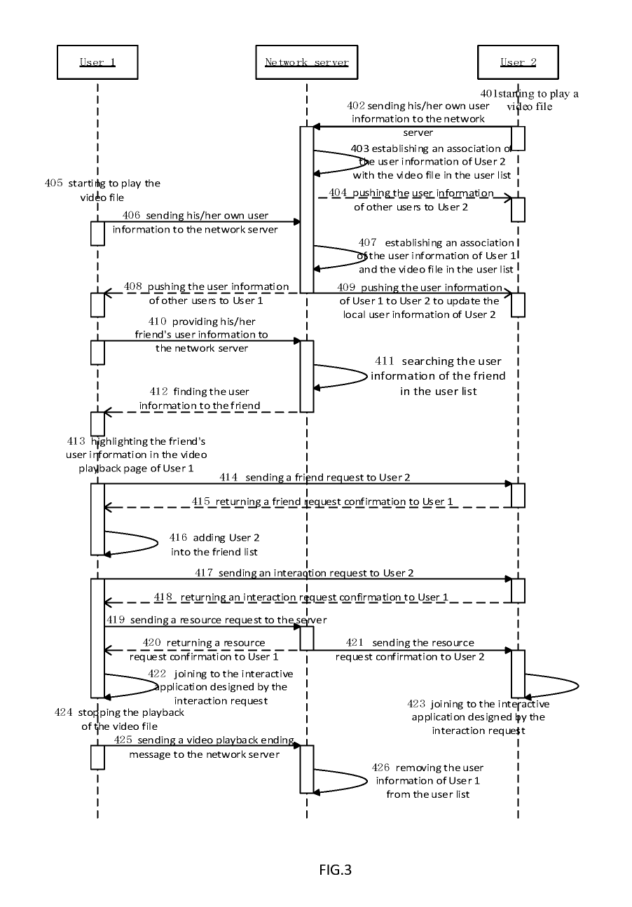

Now, in conjunction with the timing diagram, an integrated embodiment of the above-described embodiments will be described. FIG. 3 is a timing diagram of a method for interaction during video playback according to yet another embodiment of the present application. As shown, the following steps are executed in sequence in one example:
401: User 2 starting to play a video file;
402: User 2 sending his/her own user information to the network server;
403: the network server establishing an association of the user information of User 2 with the video file in the user list;
404: the network server pushing the user information of other users to User 2;
405: User lstarting to play the video file;
406: User 1 sending his/her own user information to the network server;
407: the network server establishing an association of the user information of User 1 and the video file in the user list;
408: the network server pushing the user information of other users to User 1;
409: the network server pushing the user information of User 1 to User 2 to update the local user information of User 2;
410: User 1 providing his/her friend's user information to the network server;
411: the network server searching the user information of the friend in the user list;
412, if finding the user information to the friend, then the network server return a message of find the friend to User 1;
413: highlighting the friend's user information in the video playback page of User 1;
414: User 1 sending a friend request to User 2;
415: after accepting the friend request, User 2 returning a friend request confirmation to User 1;
416: User 1 adding User 2 into the friend list;
417: User 1 sending an interaction request to User 2;
418:after accepting the interaction request, User 2 returning an interaction request confirmation to User 1;
419: after receiving the interaction request confirmation, User 1 sending a resource request to the server;
420: after the available resource being prepared, the server returning a resource request confirmation to User 1;
421: after the available resource being prepared, the server sending the resource request confirmation to User 2 at the same time;
422: User 1 joining to the interactive application designed by the interaction request;
423: User 2 joining to the interactive application designed by the interaction request;
424: User 1 stopping the playback of the video file;
425: User 1 sending a video playback ending message to the network server;
426: the network server removing the user information of User 1 from the user list.

As it can be seen from the example, when User 1 starts to play a video file following User 2, User 2 can update his local user information to add the user information of User 1 at the time of User 1 acquiring the user list, so that it can be ensured that the local user information of User 2 is always the user information of all the users watching the video file at now.

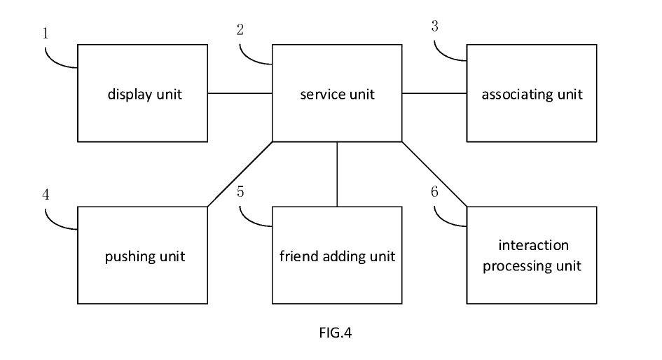

FIG. 4 is a schematic view of a system for interaction during video playback according to an embodiment of the present application as shown, the present application also provides a system for interaction during video playback, including:
a display unit 1 configured to display a video playback page;
a service unit 2 configured to store a user list and a video file and also for providing the other service supports, wherein the user list is used for multi-user access;
an associating unit 3, for after a user starting to play a video file, establishing an association of the user information of the user with the video file in a preset user list, and for after stopping to play the video file, removing the association of the user information of the user with the video file from the user list; and
a pushing unit 4, configured to acquire the user information of other users who are playing the video file from the user list during the video file being played by the user, and pushing the user information of the other users to a display page of the played video file.

Further, the pushing unit 4 includes a playback preference comparing module, configured to acquire the playback preferences of the other users, wherein the playback preference is a ratio of the number of each type of video files played by any user to the number of all video files played by the same user; comparing the playback preference of the user with the playback preferences of the other users to obtain a preference similarity; and when pushing the user information, preferably pushing the user information of those of the other users who have a high preference similarity to the user.

Preferably, the system further includes:
a friend adding unit 5, configured to select at least one of the other users to send a friend request according to the pushed user information of the other users, wherein the friend request includes the user information of the user and playback preference of the user; popping up a tab including the user information and the playback preference of the user in the page of the video file being played by the selected user; and if receiving a confirmation of the friend request from the selected other user, adding the selected other user into a friend list of the user.

Preferably, the pushing unit 4 is further configured to acquire the friend list of the user which includes the user information of a friend of the user; searching the user information of the friend in the user information of the other users; and highlighting the user information of the friend.

Preferably, the system further includes an interaction processing unit 6, configured toacquire an interaction request of the user sent to the other user, wherein the interaction request includes a type of interactive application; when receiving a confirmation of the interaction request returned from the other user, the interaction processing unit is configured to send a resource request to the server, wherein the resource request includes storage space size and network bandwidth; and when receiving a confirmation of the resource request from the server, adding the user into the interactive application designated by the interaction request.

Preferably, the interaction processing unit includes:
a chat channel module, configured to control a chat channel, wherein the chat channel includes a network link between two users and interactive windows respectively arranged in the video playback pages of respective users;
a discussion group module, configured to control a discussion group, wherein the discussion group includes a network link between two or more users and interactive windows respectively arranged in the video playback pages of respective users; and
an online screening room module, configured to control an online screening room, wherein the online screening room includes a network link between two or more users, a video transmission link between multi-users and the server, and interactive windows which is independent of the video playback pages of respective users respectively and have a function of playing a video.

Yet another aspect of an embodiment of the present application further provides a device, including:
one or more processor(s); and
a memory for storing an operating instruction; wherein the one or more processor(s) is/are configured to acquire the operation instruction from the memory to execute the steps of:
when starting to play a video file, establishing an association of the user information of a user with the video file in a preset user list, wherein the user list is used for multi-user access;
during the video file being played by the user, acquiring the user information of other users who are playing the video file from the user list, and pushing the user information of the other users to a display page of the video file; and
when ending the playing of the video file, removing the association of the user information of the user with the video file from the user list.

In some alternative embodiments, the processor is further configured to execute the steps of:
acquiring playback preferences of the other users, wherein the playback preference is a ratio of the number of each type of video files played by any user to the number of all video files played by the same user;
comparing the playback preference of the user with the playback preferences of the other users to obtain a preference similarity; and
when pushing the user information, preferably pushing the user information of those of the other users who have a high preference similarity to the user.

In some alternative embodiments, the processor is further configured to executing the steps of:
according to the pushed user information of the other users, selecting at least one of the other users to send a friend request, and the friend request includes the user information and playback preference of the user;
popping up a tab including the user information and the playback preference of the user in the page of the video file being played by the selected user; and
if receiving a confirmation of the friend request from the selected user, adding the selected user into a friend list of the user.

In some alternative embodiments, the processor is further configured to execute:
acquiring a friend list of the user which including the user information of a friend of the user;
searching the user information of the friend in the user information of the other users; and
highlighting the user information of the friend.

In some alternative embodiments, the processor is further configured to execute:
acquiring an interaction request of the user sending to the other user, wherein the interaction request includes a type of interactive application;
when receiving a confirmation of the interaction request returned from the other user, sending a resource request to the server, wherein the resource request include storage space size and network bandwidth; and
when receiving a confirmation of the resource request from the server, adding the user into the interactive application designated by the interaction request.

In some alternative embodiments, the types of interactive application include chat channel, discussion group, online screening room; wherein
the chat channel includes a network link between two users and interactive windows respectively arranged in the video playback pages of respective users;
the discussion group includes a network link between two or more users and interactive windows respectively arranged in the video playback pages of respective users; and
the online screening room includes a network link between two or more users, a video transmission link between multiple users and the server, and the interactive windows which is independent of the video playback pages of respective users respectively and have a function of playing a video.

As can be seen from the above, the method, system and device for interaction during video playback provided by the embodiments of the present application can provide the user information of other user who is watching the video for the video user and select the other user who has the similar interest and preference with the user as an interactive target of the user; and further can provide the solutions such as establishing one to one chat channel or multi-user discussion group for the users who are watching the video together, so that the users can perform various interactions while watching the video to enhance the interactive function of the video sites and applications.

In addition, typically, the device of the present disclosure can be a variety of electronic terminal devices such as mobile phone, personal digital assistant (PDA), tablet PC (PAD), smart TV, etc., so that the scope of the disclosure should not be limited to a specific type of electronic device. The system of the present disclosure can be applied in any one of the above electronic terminal device in the form of electronic hardware, computer software or a combination thereof.

Furthermore, the method according to the present disclosure may also be implemented as a computer program executed by CPU, and the computer program may be stored in a computer-readable storage medium. When the computer program is executed by CPU, the above functions defined in the methods of the present disclosure are executed.

Furthermore, the above-described method steps and system units can also be implemented by using a controller and a computer-readable storage medium for storing a computer program to make the controller to achieve the above steps or unit functions.

Additionally, it should be appreciated that the computer-readable storage medium as described herein (for example, memory) may be volatile memory or nonvolatile memory, or can include both volatile memory and nonvolatile memory. As an example without any limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM) which can act as external cache RAM memory. As an example without any limitation, RAM is available in many forms, such as synchronous RAM (DRAM), dynamic RAM (DRAM), synchronous DRAM (SDRAM), double data rate SDRAM (DDR SDRAM), enhanced SDRAM (ESDRAM), sync link DRAM (SLDRAM) and direct RambusRAM (DRRAM). The disclosed aspects of the storage devices are intended to include, but not limited to these and other suitable types of memory.

Those skilled in the art will also understand that a combination of the illustrative logical sections, modules, circuits, and algorithm steps described in this disclosure may be implemented as electronic hardware, computer software, or both. To clearly illustrate the interchangeability between hardware and software, various illustrative components, sections, modules, circuits, and functions of steps have been generally described. Whether such function is implemented as software or hardware is depended on the particular application and the design constraints imposed on the whole system. Those skilled in the art can achieve the functions for each particular application in various ways, but such implementing decisions should not be interpreted as a departure from the scope of the present disclosure.

A combination of the illustrative logical sections, modules, and circuits can be implemented or executed by using the following components designed to perform the functions described herein: general purpose processor (GPP), digital signal processor (DSP), dedicated integrated circuit (ASIC), field programmable gate array (FPGA) or other programmable logic device, discrete gate or transistor logic, discrete hardware components or any combination thereof. The GPP may be a microprocessor, but in the alternative, the processor may be any conventional processor, controller, microcontroller, or state machine. The processor may also be implemented as a combination of computing devices, e.g., a combination of DSP and microprocessor, a plurality of microprocessors, one or more microprocessors with a DSP core, or any other such configuration.

A combination of the steps of method or algorithm described herein may be contained directly in hardware, software module executed by a processor, or both. The software module may reside in RAM memory, flash memory, ROM memory, EPROM memory, EEPROM memory, registers, hard disk, removable disk, CD-ROM known in the art or any other form of storage medium. An exemplary storage medium is coupled to the processor such that the processor can read information from the storage medium or write information to the storage medium. Alternatively, the storage medium may be integrated into the processor. The processor and the storage medium may reside in ASIC. ASIC may reside in a user terminal. In one alternative, the processor and the storage medium may reside as discrete components in a user terminal.

In one or more exemplary designs, the functions described herein may be implemented in hardware, software, firmware, or any combination thereof. If implemented in software, the functions may be transmitted as one or more instructions or codes stored on a computer readable medium or by a computer-readable medium. Computer-readable medium includes both computer storage medium and communication medium, and the communication medium includes any medium contributed to transmit a computer program from one place to another. The storage medium may be any available medium accessible by a general purpose or special purpose computer. As an example without any restriction, the computer-readable medium can include RAM, ROM, EEPROM, CD-ROM or other optical disk storage, magnetic disk storage or other magnetic storage devices, or can be any other medium for carrying or storing the desired program codes in the form of instruction or data structures and can be accessed by or via a general purpose or special purpose computer. Also, any connection can be properly termed as a computer-readable medium. For example, if using a coaxial cable, fiber optic cable, twisted pair, digital subscriber line (DSL) or wireless technologies such as infrared, radio, and microwave to transmit software from website, server, or other remote source, the coaxial cable, fiber optic cable, twisted pair, DSL, or wireless technologies such as infrared, radio, and microwave are included in the definition of medium. As used herein, the terms of disk and disc include CD-ROM disc (CD), laser disc, optical disc, digital versatile disc (DVD), floppy disk and Blu-ray disc where the disk usually reproduces data magnetically and the disc reproduces data optically with lasers. Combinations of the above should also be included within the scope of computer-readable medium.

It should be understood that various changes and modifications may be made to the exemplary embodiments disclosed herein, without departing from the scopes of the disclosure defined in the appended claims. The functions, steps and/or actions of the method claims disclosed herein do not have to be executed in any particular order. Furthermore, although elements of the present disclosure may be described or claimed as an individual form, but a plurality can also be envisaged unless explicitly restricted to single.

It should be understood that, as used herein, unless the context clearly supports exceptions, the singular forms “a” (“a”, “an”, “the”) is intended to include the plural forms. It should also be understood that “and/or” used herein is intended to include any and all possible combinations of one or more of the associated listed items.

The serial number of the embodiments herein is merely configured to illustration without representing the merits of the embodiments.

Those ordinary skilled in the art will appreciate that all or part of the steps to achieve the above-described embodiments may be accomplished by hardware or by instructing relevant hardware via program, and the program may be stored in a computer readable storage medium such as read-only memory, magnetic disk or optical disc.

Those ordinary skilled in the art will appreciate that any of the embodiments discussed are exemplary only without intended to imply that the scopes of the present disclosure (including claims) are limited to these examples; the embodiments or the features in the different embodiments may be combined and the steps may be implemented in any order in accordance with the idea of the present application, and there are many other variations of the different aspects of the present application as described herein without description in the details for simplicity. Thus, any omissions, modifications, equivalent replacements and improvements made in the spirit and principles of the present application should be included within the scopes of the present application.

What is claimed is:

1. A method for interaction during video playback, which is applied in a server, comprising:
when starting to play a video file, establishing an association of user information of a user with the video file in a preset user list, wherein the user list is used for multi-users access;
during the video file being played by the user, acquiring user information of other users who are playing the video file from the user list, and pushing the user information of the other users to a display page of the played video file; and
when ending the playing of the video file, removing the association of the user information of the user with the video file from the user list.

2. The method according to claim 1, wherein the pushing the user information of the other users to a display page of the video file comprises:
acquiring playback preferences of the other users, wherein the playback preference is a ratio of the number of each type of video files played by any user to the number of all video files played by the same user;
comparing the playback preference of the user with the playback preferences of the other users to obtain a preference similarity; and
when pushing the user information, preferably pushing the user information of those of the other users who have a high preference similarity to the user.

3. The method according to claim 1, wherein after pushing the user information of the other users to a display page of the video file, the method further comprises a step of adding the other users as the user's friends, which comprises:
according to the pushed user information of the other users, selecting at least one of the other users to send a friend request, wherein the friend request includes the user information of the user and the playback preference of the user;
popping up a tab including the user information of the user and the playback preference of the user in the page of the video file being played by the selected other user; and
if receiving a confirmation of the friend request from the selected other user, adding the selected other user into a friend list of the user.

4. The method according to claim 1, wherein after pushing the user information of the other users to a display page of the playing video file, the method further comprises:
acquiring a friend list of the user which comprises the user information of a friend of the user;
searching the user information of the friend in the user information of the other users; and
highlighting the user information of the friend.

5. The method according to claim 1, wherein after the step of pushing the user information of the other users to a display page of the video file, the method further comprises:
acquiring an interaction request of the user sent to the other user, wherein the interaction request comprises a type of interactive application;
when receiving a confirmation of the interaction request returned from the other user, sending a resource request to the server, wherein the resource request includes a storage space size and a network bandwidth; and
when receiving a confirmation of the resource request from the server, adding the user into the interactive application designated by the interaction request.

6. The method according to claim 5, wherein the type of interactive application comprises chat channel, discussion group, online screening room; wherein
the chat channel comprises a network link between two users and interactive windows respectively arranged in the video playback pages of respective users;
the discussion group comprises a network link between two or more users and interactive windows respectively arranged in the video playback pages of respective users; and
the online screening room comprises a network link between two or more users, a video transmission link between multiple users and the server, and interactive windows which are independent of the video playback pages of respective users respectively and have a function of playing a video.

7. A device, comprising:
one or more processor(s); and
a memory for storing an operating instruction;
wherein the one or more processor(s)is/are configured to acquire the operation instruction from the memory to execute:
when starting to play a video file, establishing an association of user information of a user with the video file in a preset user list, wherein the user list is used for multi-user access;
during the video file being played by the user, acquiring the user information of other users who are playing the video file from the user list, and pushing the user information of the other users to a display page of the video file; and
when ending the playing of the video file, removing the association of the user information of the user with the video file from the user list.

8. The device according to 7, wherein the processor is further configured to execute:
acquiring playback preferences of the other users, wherein the playback preference is a ratio of the number of each type of video files played by any user to the number of all video files played by the user;
comparing the playback preference of the user with the playback preferences of the other users to obtain a preference similarity; and
when pushing the user information, preferably pushing the user information of those of the other users who have a high preference similarity to the user.

9. The device according to 7, wherein the processor is further configured to execute:
according to the pushed user information of the other users, selecting at least one of the other users to send a friend request, wherein the friend request includes the user information and playback preference of the user;
popping up a tab including the user information and the playback preference of the user in the page of the video file being played by the selected user; and
if receiving a confirmation of the friend request from the selected user, then adding the selected other user into a friend list of the user.

10. The device according to 7, wherein the processor is further configured to execute:
acquiring a friend list of the user which comprises the user information of a friend of the user;
searching the user information of the friend in the user information of the other users; and
highlighting the user information of the friend.

11. The device according to 7, wherein the processor is further configured to execute:
acquiring an interaction request of the user sending to the other user, wherein the interaction request includes comprises a type of interactive application;
when receiving a confirmation of the interaction request returned from the other user, sending a resource request to the server, wherein the resource request include storage space size and network bandwidth; and
when receiving a confirmation of the resource request from the server, adding the user into the interactive application designated by the interaction request.

12. The device according to 11, wherein the types of interactive application include chat channel, discussion group, online screening room; wherein
the chat channel comprises a network link between two users and interactive windows respectively arranged in the video playback pages of respective users;
the discussion group comprises a network link between two or more users and interactive windows respectively arranged in the video playback pages of respective users; and
the online screening room comprises a network link between two or more users, a video transmission link between multiple users and the server, and interactive windows which is independent of the video playback pages of respective users respectively and have a function of playing a video.
